(19) United States
(12) Patent Application Publication
(10) Pub. No.: US 2020/0331458 A1
(43) Pub. Date: Oct. 22, 2020

(54) VEHICLE CONTROL SYSTEM, VEHICLE CONTROL METHOD, AND STORAGE MEDIUM

(71) Applicant: HONDA MOTOR CO., LTD., Minato-ku, Tokyo (JP)

(72) Inventors: Yoshifumi Nakamura, Wako-shi (JP); Toshiyuki Kaji, Wako-shi (JP)

(21) Appl. No.: 16/957,734

(22) PCT Filed: Dec. 28, 2017
(86) PCT No.: PCT/JP2017/047255

§ 371 Date: Jun. 25, 2020

(51) Int. Cl. B60W 30/00; B60W 40/02; B60W 40/08

(52) U.S. Cl. CPC B60W 30/00; B60W 40/08; B60W 40/02

(57) ABSTRACT

A vehicle control system includes: a recognizer (130) configured to recognize a surrounding situation of a vehicle; a vehicle controller (120 and 160) configured to perform driving support to control one or both of steering and a deceleration or acceleration of the vehicle based on the surrounding situation recognized by the recognizer; a vigilance estimator (184) configured to estimate vigilance of a driver in the vehicle based on a detection result from a detector provided in the vehicle; and a task determiner (186) configured to determine a task requested of the driver while the driving support is performed by the vehicle controller and configured to raise a load of the task requested of the driver when the vigilance of the driver estimated by the vigilance estimator is lowered.

### TECHNICAL FIELD

The present invention relates to a vehicle control system, a vehicle control method, and a storage medium.

### BACKGROUND ART

In recent years, studies of automated vehicle control have been conducted. Workloads of drivers are reduced when automated control is performed on vehicles. On the other hand, drivers increasingly feel drowsy, and thus, for example, the drivers insufficiently monitor surroundings in some cases. In the related art, a device that determines a human drowsiness level and outputs a warning or the like when the drowsiness level exceeds a threshold is known (see Patent Literature 1).

### CITATION LIST

### Patent Literature

### Patent Literature 1

Japanese Unexamined Patent Application, First Publication No. 2008-206688

### SUMMARY OF INVENTION

### Technical Problem

In the device of the related art, however, when determination precision of the drowsiness level is not high, there is a possibility of warning being frequently output even though a driver is not drowsy. In such a situation, a driver may feel unpleasant and there is concern of marketability deteriorating. In addition, the driver may have a distrust of use of the device and there is concern of the driver stopping use of the device. In this case, deterioration of vigilance of the driver cannot be sufficiently inhibited.

The present invention is devised in view of such circumstances and an objective of the present invention is to provide a vehicle control system, a vehicle control method, and a storage medium capable of inhibiting deterioration of vigilance of a driver.

### Solution to Problem

(1) A vehicle control system includes: a recognizer configured to recognize a surrounding situation of a vehicle; a vehicle controller configured to perform driving support to control one or both of steering and a deceleration or acceleration of the vehicle based on the surrounding situation recognized by the recognizer; a vigilance estimator configured to estimate vigilance of a driver in the vehicle based on a detection result from a detector provided in the vehicle; and a task determiner configured to determine a task requested of the driver while the driving support is performed by the vehicle controller and configured to raise a load of the task requested of the driver when the vigilance of the driver estimated by the vigilance estimator is lowered.

(2) In the vehicle control system according to (1), when the task determiner raises the load of the task requested of the driver, the task determiner may perform at least one of increasing the number of tasks requested of the driver, adding a task of causing the driver to move at least a part of a body of the driver, raising an extent of thinking of a task of causing the driver to think, and changing to a task with a higher degree of driving association.

(3) In the vehicle control system according to (1), the vehicle controller may switch between first and second driving modes at a predetermined timing and perform the driving support and switches to the first driving mode when the vigilance of the driver estimated by the vigilance estimator is lowered in the second driving mode. The second driving mode may be at least one of a driving mode in which a degree of freedom of the driver is higher than that in the first driving mode, a driving mode in which a load of a task request for the driver is less than the first driving mode, and a driving mode in which a level of the driving support by the vehicle controller is higher than that in the first driving mode.

(4) In the vehicle control system according to (3), the task determiner may exclude some exclusion tasks among a plurality of tasks requested of the driver in the first driving mode in tasks requested in the second driving mode, and add the exclusion tasks to the tasks requested in the second driving mode when the vigilance of the driver estimated by the vigilance estimator is lowered in the second driving mode.

(5) In the vehicle control system according to (4), the exclusion tasks may be detected by the detector and include at least one of a task of grasping an operator of the vehicle and a task of causing the driver to monitor a surroundings of the vehicle.

(6) In the vehicle control system according to any one of (3), the vehicle controller may switch between the first and second driving modes at the predetermined timing in accordance with a change in a traveling scenario of the vehicle, and limit the switching to the second driving mode when a predetermined condition is not satisfied after the switching to the first driving mode due to lowering of the vigilance of the driver estimated by the vigilance estimator in the second driving mode.

(7) A vehicle control method causes an in-vehicle computer to perform: recognizing a surrounding situation of a vehicle; performing driving support to control one or both of steering and a deceleration or acceleration of the vehicle based on the recognized surrounding situation; estimating vigilance of a driver in the vehicle based on a detection result from a detector provided in the vehicle; determining a task requested of the driver while the driving support is performed; and raising a load of the task requested of the driver when the estimated vigilance of the driver is lowered.

(8) A storage medium according to one aspect of the present invention is a computer-readable non-transitory storage medium storing a program, the program causes an in-vehicle computer to perform: recognizing a surrounding situation of a vehicle; performing driving support to control one or both of steering and a deceleration or acceleration of the vehicle based on the recognized surrounding situation; estimating vigilance of a driver in the vehicle based on a detection result from a detector provided in the vehicle; determining a task requested of the driver while the driving support is performed; and raising a load of the task requested of the driver when the estimated vigilance of the driver is lowered.

### Advantageous Effects of Invention

According to the aspects (1) to (8), it is possible to inhibit deterioration of vigilance of a driver.

### BRIEF DESCRIPTION OF DRAWINGS

FIG. 1 is a diagram illustrating a configuration of a vehicle system 1 in which a vehicle control system according to an embodiment is used.

FIG. 2 is a diagram showing a functional configuration of a first controller 120, a second controller 160, and a third controller 180.

FIG. 3 is a flowchart illustrating a flow of some processes performed by the third controller 180. FIG. 4 is a flowchart (part 1) illustrating a flow of processes performed by a request task determiner 186.

FIG. 5 is a flowchart (part 2) illustrating a flow of processes performed by the request task determiner 186.

FIG. 6 is a flowchart (part 3) illustrating a flow of processes performed by the request task determiner 186.

FIG. 7 is a flowchart (part 4) illustrating a flow of processes performed by the request task determiner 186.

FIG. 8 is a diagram illustrating an example of a functional configuration of a vehicle system 1A according to a second embodiment.

FIG. 9 is a diagram illustrating an example of a hardware configuration of an automated driving control unit 100 (a driving support unit 300) according to an embodiment.

### DESCRIPTION OF EMBODIMENTS

Hereinafter, embodiments of a vehicle control system, a vehicle control method, and a storage medium according to the present invention will be described with reference to the drawings.

### First Embodiment

### Overall Configuration

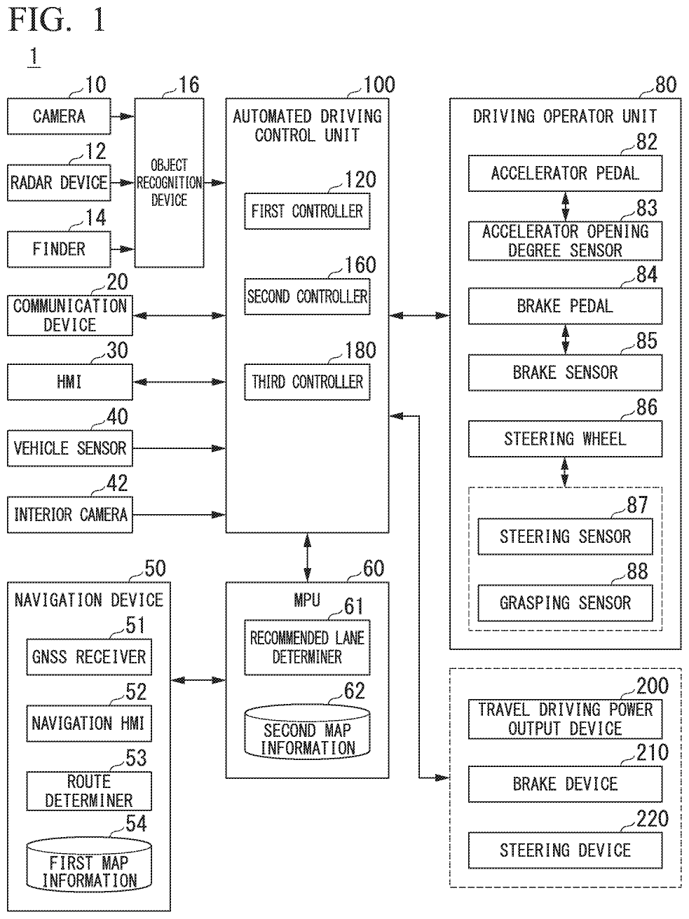

FIG. 1 is a diagram illustrating a configuration of a vehicle system 1 in which a vehicle control system according to an embodiment is used. A vehicle in which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, or a combination thereof. When the electric motor is included, the electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, an interior camera 42, a navigation device 50, a map positioning unit (MPU) 60, a driving operator unit 80, an automated driving control unit 100, a travel driving power output device 200, a brake device 210, and a steering device 220. The devices and units are connected to one another via a multiplex communication line such as a controller area network (CAN) communication line, a serial communication line, or a wireless communication network. The configuration shown in FIG. 1 is merely exemplary, a part of the configuration may be omitted, and another configuration may be further added.

The camera 10 is, for example, a digital camera that uses a solid-state image sensor such as a charged coupled device (CCD) or a complementary metal oxide semiconductor (CMOS). One camera 10 or a plurality of cameras 10 are mounted on any portion of a vehicle in which the vehicle system 1 is mounted (hereinafter referred to as an own vehicle M). When the camera 10 images a front side, the camera 10 is mounted on an upper portion of a front windshield, a rear surface of a rearview mirror, or the like. For example, the camera 10 repeatedly images the surroundings of the own vehicle M periodically. The camera 10 may be a stereo camera.

The radar device 12 radiates radio waves such as millimeter waves to the surroundings of the own vehicle M and detects radio waves (reflected waves) reflected from an object to detect at least a position (a distance from and an azimuth of) of the object. One radar device 12 or a plurality of radar devices 12 are mounted on any portion of the own vehicle M. The radar device 12 may detect a position and a speed of an object in conformity with a frequency modulated continuous wave (FM-CW) scheme.

The finder 14 is a light detection and ranging (LIDAR) finder. The finder 14 radiates light to the surroundings of the own vehicle M and measures scattered light. The finder 14 detects a distance to a target based on a time from light emission to light reception. The radiated light is, for example, pulsed laser light. One finder 14 or a plurality of finders 14 are mounted on any portions of the own vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control unit 100. The object recognition device 16 may output detection results of the camera 10, the radar device 12, and the finder 14 to the automated driving control unit 100 without any change, as necessary.

The communication device 20 communicates with another vehicle around the own vehicle M or various server devices via radio base stations using, for example, a cellular network, a Wi-Fi network, Bluetooth (registered trademark), dedicated short range communication (DSRC) or the like.

The HMI 30 presents various types of information to occupants of the own vehicle M and receives input operations by the occupants. The HMI 30 includes various display devices, speakers, buzzers, touch panels, switches, and keys.

The vehicle sensor 40 includes a vehicle speed sensor that detects a speed of the own vehicle M, an acceleration sensor that detects acceleration, a yaw rate sensor that detects angular velocity around a vertical axis, and an azimuth sensor that detects a direction of the own vehicle M. The vehicle sensor 40 may detects magnitude of vibration received from a road surface by the own vehicle M which is traveling.

The interior camera 42 is, for example, a digital camera in which a solid-state image sensor such as a CCD or a CMOS is used. The interior camera 42 is mounted at a position at which a user (for example, the user is an occupant sitting on a driver seat and is referred to as a driver) of the own vehicle M can be imaged. For example, the interior camera 42 images a region of an imaging target at a predetermined period and outputs captured images to the automated driving control unit 100. The interior camera 42 may be a stereo camera.

The navigation device 50 includes, for example, a global navigation satellite system (GNSS) receiver 51, a navigation HMI 52, and a route determiner 53 and retains first map information 54 in a storage device such as a hard disk drive (HDD) or a flash memory. The GNSS receiver 51 specifies a position of the own vehicle M based on signals received from GNSS satellites. The position of the own vehicle M may be specified or complemented by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 determines, for example, a route from a position of the own vehicle M specified by the GNSS receiver 51 (or any input position) to a destination input by an occupant using the navigation HMI 52 (hereinafter referred to as a route on a map) with reference to the first map information 54. The first map information 54 is, for example, information in which a road shape is expressed by links indicating roads and nodes connected by the links. The first map information 54 may include curvatures of roads and point of interest (POI) information. The route on the map determined by the route determiner 53 is output to the MPU 60. The navigation device 50 may perform route guidance using the navigation HMI 52 based on the route on the map determined by the route determiner 53. The navigation device 50 may be realized by, for example, a function of a terminal device such as a smartphone or a tablet terminal possessed by an occupant. The navigation device 50 may transmit a present position and a destination to a navigation server via the communication device 20 to acquire the same route as the route on the map replied from the navigation server.

The MPU 60 functions as, for example, a recommended lane determiner 61 and retains second map information 62 in a storage device such as an HDD or a flash memory. The recommended lane determiner 61 divides the route provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left. When there is a branching location in the route, a joining spot, or the like, the recommended lane determiner 61 determines a recommended lane so that the own vehicle M can travel in a reasonable route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The second map information 62 may access another device using the communication device 20 to be updated frequently.

The driving operator unit 80 includes, for example, an accelerator pedal 82, a brake pedal 84, a steering wheel 86, a shift lever, a heteromorphic steering wheel, a joystick, and other operators. The driving operator unit 80 includes an operator sensor. The operator sensor includes, for example, an accelerator opening degree sensor 83, a brake sensor 85, a steering sensor 87, and a grasping sensor 88. The accelerator opening degree sensor 83, the brake sensor 85, the steering sensor 87, and the grasping sensor 88 output detection results to the automated driving control unit 100 or the travel driving power output device 200 and one or both of the brake device 210 and the steering device 220.

The accelerator opening degree sensor 83 detects an operation amount (accelerator opening degree) of the accelerator pedal 82. The brake sensor 85 detects an operation amount of the brake pedal 84. The brake sensor 85 detects, for example, a step amount of the brake pedal based on a change in the brake pedal or a fluid pressure of a master cylinder of the brake device 210. The steering sensor 87 detects an operation amount of the steering wheel 86. The steering sensor 87 is provided on, for example, a steering shaft and detects an operation amount of the steering wheel 86 based on a rotational angle of the steering shaft. The steering sensor 87 may detect steering torque and detects an operation amount of the steering wheel 86 based on the detected steering torque.

The grasping sensor 88 is, for example, an electrostatic capacitance sensor provided along a circumferential direction of the steering wheel 86. The grasping sensor 88 detects a contact of an object on a detection target region as a change in electrostatic capacitance.

The accelerator opening degree sensor 83, the brake sensor 85, the steering sensor 87, and the grasping sensor 88 each output the detection results to the automated driving control unit 100.

The automated driving control unit 100 includes, for example, a first controller 120, a second controller 160, and a third controller 180. The first controller 120 and the second controller 160 are controllers that mainly perform driving support (including automated driving) of the own vehicle M. Each of the first controller 120, the second controller 160, and the third controller 180 is realized, for example, by causing a hardware processor such as a central processing unit (CPU) to execute a program (software). Some or all of the constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The details of the automated driving control unit 100 will be described below.

The travel driving power output device 200 outputs travel driving power (toque) for causing the own vehicle M to travel to a driving wheel. The travel driving power output device 200 includes, for example, a combination of an internal combustion engine, an electric motor, and a transmission and an electronic control unit (ECU) controlling them. The ECU controls the foregoing configuration in accordance with information input from the second controller 160 or information input from the driving operator unit 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator unit 80 such that a brake torque in accordance with a brake operation is output to each wheel. The brake device 210 may include a mechanism that transmits a hydraulic pressure generated in response to an operation of the brake pedal 84 included in the driving operator unit 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second controller 160 or information input from the driving operator unit 80.

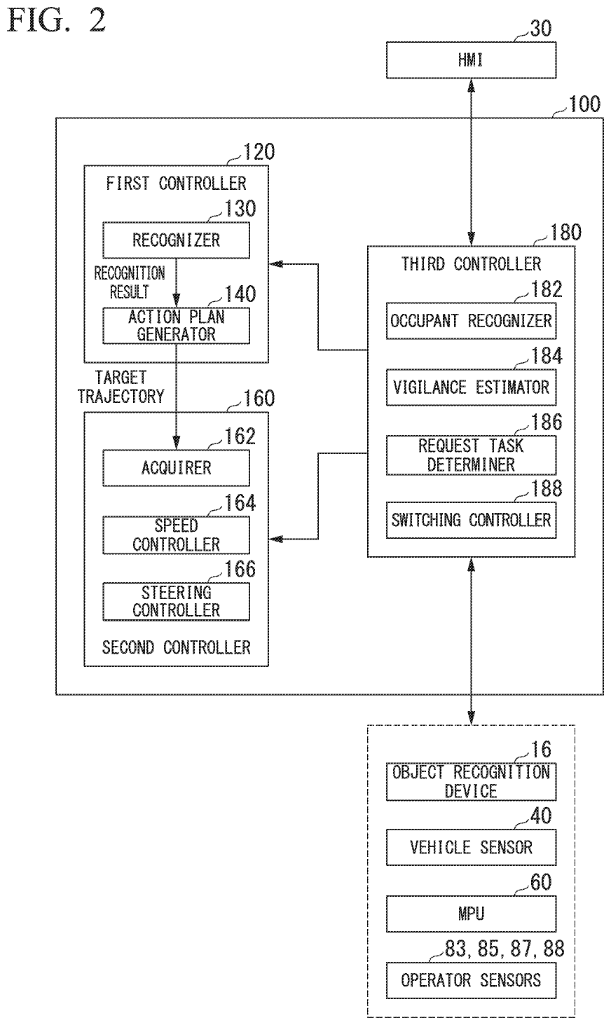

FIG. 2 is a diagram illustrating a functional configuration of the first controller 120, the second controller 160, and the third controller 180. The first controller 120 and the second controller 160 control the own vehicle M in accordance with a driving mode of the vehicle in response to an instruction of the third controller 180. The details will be described below.

The first controller 120 includes, for example, a recognizer 130 and an action plan generator 140. The first controller 120 realizes, for example, a function by artificial intelligence (AI) and a function by a model given in advance in parallel. For example, a function of “recognizing an intersection” is realized by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of driving support (including automated driving) is guaranteed.

The recognizer 130 recognizes states such as a position, a speed, acceleration, or the like of an object near the own vehicle M based on information input from the camera 10, the radar device 12, and the finder 14 via the object recognition device 16. For example, the position of the object is recognized as a position on the absolute coordinates in which a representative point (a center of gravity, a center of a driving shaft, or the like) of the own vehicle M is the origin and is used for control. The position of the object may be represented as a representative point such as a center of gravity, a corner, or the like of the object or may be represented as expressed regions. A “state” of an object may include both an acceleration and jerk of the object or an “action state” (for example, whether a vehicle is changing a lane or is attempting to change the lane). The recognizer 130 recognizes the shape of a curve in which the own vehicle M passes from now based on images captured by the camera 10. The recognizer 130 converts the shape of the curve into an actual plane using the images captured by the camera 10 and outputs, for example, 2-dimensional point sequence information or information expressed using a model equal to the 2-dimensional point sequence information as information expressing the shape of the curve to the action plan generator 140.

The recognizer 130 recognizes, for example, a lane in which the own vehicle M is traveling (a travel lane). For example, the recognizer 130 recognizes the travel lane by comparing patterns of road mark lines (for example, arrangement of continuous lines and broken lines) obtained from the second map information 62 with patterns of road mark lines around the own vehicle M recognized from images captured by the camera 10. The recognizer 130 may recognize a travel lane by recognizing runway boundaries (road boundaries) including road mark lines or shoulders, curbstones, median strips, and guardrails without being limited to road mark lines. In this recognition, the position of the own vehicle M acquired from the navigation device 50 or a process result by INS may be added. The recognizer 130 recognizes temporary stop lines, obstacles, red signals, toll gates, and other road events.

The recognizer 130 recognizes a position or a posture of the own vehicle M in the travel lane when the recognizer 130 recognizes the travel lane. For example, the recognizer 130 may recognize a deviation from the middle of a lane of the standard point of the own vehicle M and an angle formed with a line extending along the middle of a lane in the travel direction of the own vehicle M as a relative position and posture of the own vehicle M to the travel lane. Instead of this, the recognizer 130 may recognize a position or the like of the standard point of the own vehicle M with respect to any side end portion (a road mark line or a road boundary) of a travel lane as the relative position of the own vehicle M to the travel lane.

The recognizer 130 may derive recognition precision in the foregoing recognition process and output the recognition precision as recognition precision information to the action plan generator 140. For example, the recognizer 130 generates the recognition precision information for a given period of time based on a frequency at which a road mark line can be recognized.

The action plan generator 140 determines events sequentially performed in automated driving so that the own vehicle M is traveling along a recommended lane determined by the recommended lane determiner 61 and can handle a surrounding situation of the own vehicle M in principle. The events include, for example, a constant speed traveling event in which a vehicle is traveling in a traveling lane at a constant speed, a following traveling event in which a vehicle follows a front vehicle, an overtaking event in which a vehicle takes over a front vehicle, an avoiding event in which braking and/or steering is performed to avoid approach to an obstacle, a curve traveling event in which a vehicle is traveling in a curve, a passing event in which a vehicle passes a predetermined point such as an intersection, a crosswalk, or a railroad crossing, a lane changing event, a joining event, a branching event, an automated stopping event, and a takeover event in which automated driving ends to switch to manual driving.

The action plan generator 140 generates a target trajectory in which the own vehicle M will travel in future in accordance with an activated event. The details of each functional unit will be described below. The target trajectory includes, for example, a speed element. For example, the target trajectory is expressed by arranging spots (trajectory points) at which the own vehicle M will arrive in sequence. The trajectory point is a spot at which the own vehicle M will arrive for each predetermined travel distance (for example, about several [m]) in a distance along a road. Apart from the trajectory points, target acceleration and a target speed are generated as parts of the target trajectory for each of predetermined sampling times (for example, about every fractions of a second). The trajectory point may be a position at which the own vehicle M will arrive at the sampling time for each predetermined sampling time. In this case, information regarding the target acceleration or the target speed is expressed according to an interval between the trajectory points.

The action plan generator 140 generates, for example, a target trajectory based on a recommended lane. The recommended lane is set so that the own vehicle is traveling conveniently along a route to a destination. When the own vehicle arrives in front of a predetermined distance (which may be determined in accordance with a type of event) of a switching spot of the recommended lane, the action plan generator 140 activates a passing event, a lane changing event, a branching event, a joining event, and the like. When it is necessary to avoid an obstacle during execution of each event, an avoidance trajectory is generated to avoid the obstacle.

The action plan generator 140 determines a driving mode appropriate for a traveling scenario based on detection results of the camera 10, the radar device 12, the finder 14, the object recognition device 16, the vehicle sensor 40, the MPU 60, the operation sensors (the accelerator opening degree sensor 83, the brake sensor 85, the steering sensor 87, and the grasping sensor 88), or the like and controls the own vehicle M in accordance with the determined driving mode. For example, the action plan generator 140 determines a traveling situation based on the above-described detection results and switches the driving mode to the driving mode in accordance with the determination results. The action plan generator 140 may switch the driving mode in accordance with a change in a traveling speed of the own vehicle M. The driving mode includes, for example, a manual driving mode, a first automated driving mode, a second automated driving mode, and a third automated driving mode. In the embodiment, modes for the automated driving are defined as the first to third driving modes for convenience.

The manual driving mode is a mode in which the own vehicle M is controlled by allowing a driver of the own vehicle M to manually operate the accelerator pedal 82, the brake pedal 84, or the steering wheel 86.

The first to third automated driving modes are a first automated driving mode, a second automated driving mode, and a third automated driving mode that are arranged in order in which a load of a task requested of a driver of the own vehicle M in a mode in which automated driving is performed is higher. That is, when the automated driving modes are sorted hierarchically in accordance with a load of a task requested of the driver, the first automated driving mode is a lowest driving mode and the third automated driving mode is a highest driving mode. That is, a higher driving mode is at least one of a driving mode in which the degree of freedom of the driver is higher than that in a lower driving mode, a driving mode in which a load of a task requested of the driver is lower than the lower driving mode, and a driving mode in which a level of driving support is higher than that in the lower driving mode.

A task requested of the driver in the first automated driving mode is, for example, a task for allowing the steering wheel 86 to be grasped and monitoring surroundings of the own vehicle M. The task for monitoring the surroundings is, for example, a task for orienting a visual line to a traveling direction of the own vehicle M and the surroundings. A traveling situation performed in the first automated driving mode includes, for example, a curve road of a lamp or the like of a highway or a section in which the shape of a road near a tollgate or the like is different from a simple straight line.

A task requested of the driver in the second automated driving mode is, for example, a task for monitoring the surroundings of the own vehicle M. A traveling situation performed in the second automated driving mode includes, for example, a section in which the shape of a road of a main lane or the like of a highway is a straight line or close to the straight line.

The third automated driving mode is, for example, a mode in which automated driving is performed without request any task for the driver of the own vehicle M. A traveling situation performed in the third automated driving mode includes, for example, a situation in which a speed of the own vehicle M is equal to or less than a predetermined speed and an inter-vehicle distance from a front vehicle is within a predetermined distance.

The second controller 160 controls the travel driving power output device 200, the brake device 210, and the steering device 220 such that the own vehicle M passes along a target trajectory generated by the action plan generator 140 at a scheduled time.

The second controller 160 includes, for example, an acquirer 162, a speed controller 164, and a steering controller 166. The acquirer 162 acquires information regarding a target trajectory (trajectory points) generated by the action plan generator 140 and stores the information in a memory (not shown). The speed controller 164 controls the travel driving power output device 200 or the brake device 210 based on a speed element incidental to the target trajectory stored in the memory. The steering controller 166 controls the steering device 220 in accordance with a curve state of the target trajectory stored in the memory. Processes of the speed controller 164 and the steering controller 166 are realized, for example, by combining feed-forward control and feedback control. For example, the steering controller 166 performs the feed-forward control in accordance with a curvature of a road in front of the own vehicle M and the feedback control based on deviation from the target trajectory in combination.

The third controller 180 includes, for example, an occupant recognizer 182, a vigilance estimator 184, a request task determiner 186, and a switching controller 188.

The occupant recognizer 182 analyzes an image captured by the interior camera 42 and recognizes a state of an occupant based on an analysis result. Based on the analysis result of the image, the occupant recognizer 182 determines whether the occupant is in a drowsing state or determines whether the occupant is monitoring the surroundings of the own vehicle M. For example, when a state in which the head of the occupant is oriented in a floor direction of the own vehicle M continues for a predetermined time or when eyelids of the occupant are continuously closed for a predetermined time or more, the occupant recognizer 182 determines that the occupant is in a drowsing state.

The occupant recognizer 182 determines a region to which the occupant (the driver) of the vehicle orients his or her visual line based on an analysis result of the image and determines whether the driver monitors the surroundings of the own vehicle M based on a determination result. For example, the occupant recognizer 182 detects a combination of a standard point (a portion in which eyes are not moved) on the eyes of the driver and a moving point (a portion in which the eyes are moved) from an image by using a scheme such as template matching. The combination of the standard point and the moving point is, for example, a combination of an eyelid and an iris, a combination of a cornea reflection region and a pupil. The cornea reflection region is a reflection region of infrared light in a cornea when the interior camera 42 or the like radiates infrared light toward the driver. The occupant recognizer 182 performs a conversion process or the like from an image plane to an actual plane and derives a direction of the visual line based on a position of the moving point with respect to the standard point.

The occupant recognizer 182 determines whether the driver is grasping the steering wheel 86 or determines whether the degree of grasping of the steering wheel 86 by the driver based on a detection result of the grasping sensor 88.

The vigilance estimator 184 estimates vigilance of the driver based on detection results by detectors such as various sensors (including, for example, the camera 10, the radar device 12, the finder 14, the object recognition device 16, the vehicle sensor 40, the MPU 60, the accelerator opening degree sensor 83, the brake sensor 85, the steering sensor 87, the grasping sensor 88, and the occupant recognizer 182) provided in the own vehicle M. For example, the vigilance estimator 184 estimates vigilance of the driver based on a recognition result from the occupant recognizer 182. The vigilance indicates, for example, the degree of a vigilance state step by step and includes a normal state (V1), a slight decrease (V2), and a considerable decrease (V3).

For example, the vigilance estimator 184 estimates vigilance based on a detection result from the grasping sensor 88. For example, when a change amount of electrostatic capacitance detected by the grasping sensor 88 is equal to or greater than a first threshold, the vigilance estimator 184 determines that the occupant is grasping the steering wheel 86 and estimates that the vigilance is the normal state V1. Conversely, when the change amount of electrostatic capacitance detected by the grasping sensor 88 is less than the first threshold and equal to or greater than a second threshold by a predetermined amount (where the second threshold<the first threshold), the vigilance estimator 184 determines that the occupant is not firmly grasping the steering wheel 86 and estimates that the vigilance is slightly lowered. Further, when the change amount of electrostatic capacitance detected by the grasping sensor 88 is less than the second threshold, the vigilance estimator 184 determines that the occupant is not grasping the steering wheel 86 at all and estimates that the vigilance is considerably lowered.

The vigilance estimator 184 estimates the vigilance based on a recognition result from the occupant recognizer 182. For example, the vigilance estimator 184 estimates that the vigilance is lower as a continuous time of a state in which the driver of the own vehicle M does not perform a predetermined behavior (for example, a state in which the driver is not monitoring the surroundings of the own vehicle M, a state in which the driver is not orienting his or her visual line in a traveling direction and the vicinity of the visual line, or the like) is longer. In a state in which the occupant is likely to fall asleep, the vigilance estimator 184 may determine that the vigilance is V2 in which the vigilance is slightly lowered. In a state in which the occupant is asleep, the vigilance estimator 184 may determine that the vigilance is V3 in which the vigilance is considerably lowered. Based on an analysis result of an image captured by the interior camera 42, the vigilance estimator 184 may analyze a speed of nictitation, an open state of eyes, an interval of nictitation (a time for which the eyes are continuously opened), a continuous time of nictitation (a time for which the eyes are continuously closed), or the like using artificial intelligence and may estimate a drowsiness level. The vigilance estimator 184 estimates vigilance in accordance with the estimated drowsiness level. The vigilance may be estimated in accordance with the length of a time for which the eyes are continuously closed. For example, when a time for which the eyes are continuously closed is equal to or greater than a third threshold, the vigilance estimator 184 may determine that the vigilance is V2 in which the vigilance is slightly lowered. When the time for which the eyes are continuously closed is equal to or greater than a fourth threshold (where the fourth threshold>the third threshold), the vigilance estimator 184 may determine that the vigilance is V3 in which the vigilance is considerably lowered.

The vigilance estimator 184 may estimate the vigilance in accordance with a state in which a request task is performed. For example, when the request task is occasionally not able to be performed, the vigilance estimator 184 may determine that the vigilance is V2 in which the vigilance is slightly lowered. When the request task is substantially not able to be performed, the vigilance estimator 184 may determine that the vigilance is V3 in which the vigilance is considerably lowered. When the request task can be performed within a limit time, the vigilance estimator 184 may determine that the vigilance is V2 in which the vigilance is slightly lowered. When the request task cannot be performed within the limit time, the vigilance estimator 184 may determine that the vigilance is V3 in which the vigilance is considerably lowered.

Based on a traveling scenario of the own vehicle M, the vigilance estimator 184 may estimate the vigilance of the driver. For example, when the traveling scenario corresponds to a predetermined traveling scenario of the own vehicle M, the vigilance estimator 184 estimates that the vigilance of the driver is lowered. The predetermined traveling scenario includes, for example, a scenario in which the own vehicle M is traveling for a period T1 or more (long-time travel), a scenario in which strength (average amplitude) of vibration received from a road surface by the own vehicle M which is traveling is equal to or greater than a standard value X1, a scenario in which the number of curves in traveling within a period T2 is equal to or greater than a standard value X2, a scenario in which the own vehicle M is traveling on a straight road for a period T3 or more, and a scenario in which the own vehicle M is traveling at a speed V1 or less on a congested road for a period T4 or more. The period may be a time or a distance (the same applies below). The vigilance estimator 184 determines that the vigilance is lowered as a continuous time of the predetermined traveling scenario is longer. In this way, the vigilance estimator 184 can estimate the vigilance in accordance with the degree of fatigue of the driver.

When the automated driving control unit 100 performs the driving support, the request task determiner 186 determines a task requested of the driver (hereinafter referred to as a request task). The request task determiner 186 may notify the driver of content of the determined request task using the HMI 30 or may instruct the switching controller 188 to perform a determined task. For example, when the task is a question, an inquiry, a call, an instruction, or the like addressed to the driver, the request task determiner 186 outputs content of the task using the HMI 30.

The request task includes, for example, a task in which the driver grasps the steering wheel 86 (hereinafter referred to as task 1), a task in which the driver monitors the surroundings of the own vehicle M (hereinafter referred to as task 2), a task in which the driver moves at least a part of his or her body (hereinafter referred to as task 3), a task in which the driver is caused to think (hereinafter referred to as task 4), and a task in which the driver is caused to perform a motion related to driving (hereinafter referred to as task 5). Task 3 includes, for example, a motion of raising or lowering a shoulder, a motion of raising or lowering an elbow, a motion of opening the mouth wide, a motion of blinking a plurality of times, and a motion of breathing deeply. Task 4 includes a question regarding an occupant and a question regarding a surrounding situation such as weather or an interior environment. Task 4 may include a plurality of tasks in accordance with the extent of thinking The extent of thinking may be raised by causing content of a question to be complicated. The extent of thinking may be raised by increasing the number of questions. The extent of thinking may be raised by requesting the driver to respond. The extent of thinking may be raised by limiting a response time. Task 5 includes, for example, tasks 1 and 2, a task for operating the accelerator pedal 82 and a task for operating the brake pedal 84.

The request task determiner 186 determines a request task based on a driving mode determined by the action plan generator 140 or the switching controller 188. That is, when the request task differs in accordance with the driving mode, the request task determiner 186 switches the request task in accordance with the switching of the driving mode by the action plan generator 140 or the switching controller 188. Hereinafter, request tasks determined by the request task determiner 186 based on the driving mode are referred to as a first task group. The task group may be one task or two or more tasks.

When the vigilance of the driver estimated by the vigilance estimator 184 is lowered, the request task determiner 186 raises a load of the request task. That is, the request task determiner 186 changes content of the request task to content in which a load on the driver is raised. Tasks with content in which a load on the driver is raised are referred to as a second task group.

For example, when a load of a request task is raised, the request task determiner 186 performs at least one of increasing the number of tasks included in the request task, adding a task of causing the driver to move at least a part of his or her body, raising the extent of thinking of a task of causing the driver to think, and changing to a task with a higher degree of driving association. The “task with the higher degree of driving association” includes, for example, tasks requested in the manual driving mode, such as a task in which the driver grasps the steering wheel 86, a task in which the driver monitors the surroundings of the own vehicle M, and a task in which the driver operates the accelerator pedal 82 or the brake pedal 84. When a task is changed to the task with the higher degree of driving association, a period in which the task is performed (a period in which the task is continuously performed) may be a temporary period in which a switching condition that the automated driving mode is switched to the manual driving mode is not satisfied. For example, when the switching condition is a condition that “the driver grasps the steering wheel 86 for a period T5 or more,” the period in which the task is performed is a period shorter than the period T5. After the period T5 has passed, the request task determiner 186 may exclude the task in which the driver grasps the steering wheel 86 from the request tasks and notify the driver of the exclusion from the request tasks using the HMI 30.

The raising of the load of the request task may be a result obtained when the switching controller 188 switches the driving mode.

When the vigilance of the driver estimated by the vigilance estimator 184 is lowered, the switching controller 188 changes the driving mode determined by the action plan generator 140 to the driving mode in which the load of the request task is raised. For example, when the vigilance of the driver estimated by the vigilance estimator 184 is lowered in a situation in which the automated driving control unit 100 controls the own vehicle M in a higher driving mode, the switching controller 188 switches the driving mode to a lower driving mode. For example, when the vigilance of the driver estimated by the vigilance estimator 184 is lowered during execution of the second automated driving mode, the switching controller 188 switches the driving mode to the first automated driving mode. In this way, since the load on the driver is raised and the driver is caused to perform a motion related to driving, it is possible to inhibit deterioration of the vigilance.

The raising of the load of the request task may be changing of content of a request task group determined in advance in accordance with the driving mode by the request task determiner 186. For example, irrespective of the switching or the changing of the driving mode by the action plan generator 140 or the switching controller 188, the content of the task group requested during the execution of the second automated driving mode may be raising the load of the request task by changing the content of the task group requested during execution of the first automated driving mode.

More specifically, when the action plan generator 140 switches the driving mode, for example, from the lower driving mode to the higher driving mode, the request task determiner 186 determines, as request tasks, tasks which are tasks requested in the higher driving mode and are obtained by excluding some exclusion tasks from the plurality of tasks requested of the driver in the lower driving mode. Thereafter, when the vigilance of the driver estimated by the vigilance estimator 184 is lowered during the execution of the higher driving mode, the request task determiner 186 adds the exclusion task to the request tasks which are performed in the higher driving mode. The exclusion tasks are, for example, task 1 and task 2 or the like. The exclusion tasks are determined in advance in accordance with the driving mode. In this way, since the load of the request task on the driver is high irrespective of the switching of the driving mode and an operation related to the driving is performed for the driver, it is possible to inhibit the deterioration of the vigilance and it is possible to switch the driving mode in accordance with the traveling situation or the like.

When the driving mode is switched to the higher driving mode after the load of the request task is raised and a predetermined condition is not satisfied, the action plan generator 140 may limit the switching to the higher driving mode. The predetermined condition includes, for example, passing of a period T6 from a time at which the load of the request task is raised. In this way, since a period in which the load of the request task is high continues sufficiently, it is possible to inhibit the vigilance of the driver from being lowered immediately. Even when a change in the estimated vigilance is frequent, it is possible to inhibit the frequent change in the driving mode.

### Flowchart

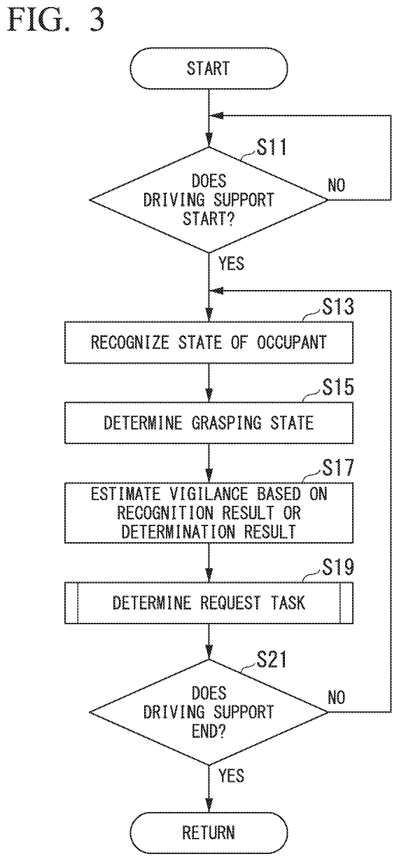

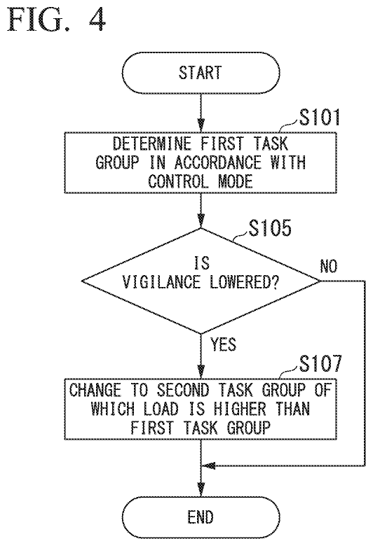

FIG. 3 is a flowchart illustrating a flow of some processes performed by the third controller 180. Description of a process in which the action plan generator 140 determines a driving mode will be omitted.

First, the third controller 180 determines whether the driving support starts (step S11). For example, when the action plan generator 140 switches the driving mode from the manual driving mode to the first automated driving mode, the third controller 180 determines that the driving support starts. When the third controller 180 determines that the driving support starts, the occupant recognizer 182 analyzes an image captured by the interior camera 42, recognizes a state of an occupant based on an analysis result, and outputs a recognition result to the vigilance estimator 184 (step S13). Based on a detection result of the grasping sensor 88, the vigilance estimator 184 determines a state in which the driver grasps the steering wheel 86 (including whether or not it is being grasped and the degree of grasping) (step S15).

Based on a recognition result from the occupant recognizer 182, determination of a grasping state, or the like, the vigilance estimator 184 estimates vigilance of the driver (step S17). The request task determiner 186 determines a request task based on a determination result determined in step S15 and a driving mode to be performed (step S19). Subsequently, the third controller 180 determines whether the driving support ends (step S21). For example, when the action plan generator 140 or the switching controller 188 switches the driving mode from the first automated driving mode to the manual driving mode, the third controller 180 determines that the driving support ends. When the driving support does not end, the third controller 180 returns to step S13 to repeat the processes.

Next, a process in which the request task determiner 186 determines a request task will be described with reference to FIGS. 4 to 6. This process is a process corresponding to step S19 of the flowchart of FIG. 3. As a processing method of the request task determiner 186, one of the processes illustrated in FIGS. 4 to 6 is set.

FIG. 4 is a flowchart (part 1) illustrating a flow of processes performed by the request task determiner 186. The request task determiner 186 determines the first task group in accordance with the driving mode (step S101). The request task determiner 186 determines whether the vigilance of the driver estimated by the vigilance estimator 184 is lowered (step S105). When the request task determiner 186 determines that the vigilance of the driver estimated by the vigilance estimator 184 is not lowered, the request task determiner 186 does not change the request task.

Conversely, when the request task determiner 186 determines that the vigilance of the driver estimated by the vigilance estimator 184 is lowered, the request task determiner 186 changes the requested task to the second task group (step S107). When the requested task is changed to the second task group, the request task determiner 186 may change the entire first task group to the second task group or may change at least some of the first task group to the second task group.

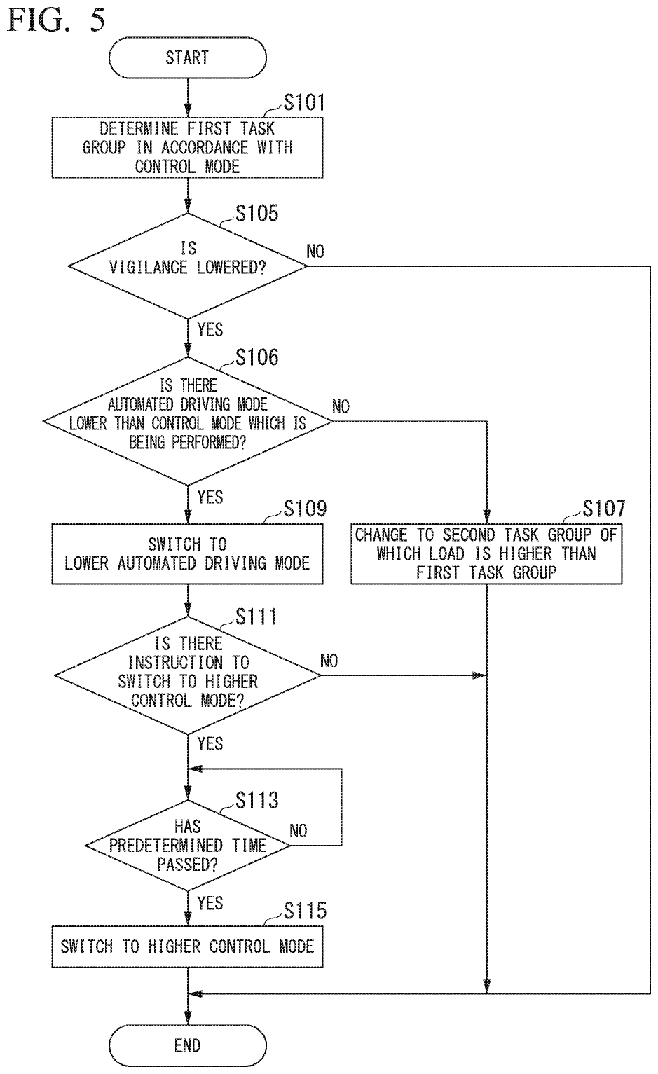

FIG. 5 is a flowchart (part 2) illustrating a flow of processes performed by the request task determiner 186. The same reference numerals are given to the same processes as the processes described in FIG. 4 and detailed description thereof will be omitted. When it is determined in step S105 that the vigilance of the driver is lowered, the request task determiner 186 determines whether there is an automated driving mode lower than a driving mode which is being performed (step S106). For example, when the first automated driving mode is performed, there is no automated driving mode lower than the first automated driving mode. Therefore, the request task determiner 186 changes the requested task to the second task group (step S107).

On the other hand, when the second automated driving mode or the third automated driving mode is being performed, there is an automated driving mode lower than the second automated driving mode or the third automated driving mode. Therefore, the request task determiner 186 instructs the switching controller 188 to switch the driving mode to an immediately lower automated driving mode (step S109). Thus, the switching controller 188 changes the driving mode to the instructed automated driving mode. When the request task determiner 186 instructs the switching controller 188 to change the driving mode, the switching controller 188 may determine to change the driving mode which is being performed to a driving mode which is one level lower and change the driving mode to the determined driving mode.

Subsequently, the request task determiner 186 determines whether the action plan generator 140 determines to switch the driving mode to a higher automated driving mode (step S111). When the driving mode is determined to be switched to the higher automated driving mode, the request task determiner 186 determines whether the period T6 has passed from the time of switching to the lower automated driving mode in step S109 (step S113). When it is determined that the period T6 has not passed, the request task determiner 186 outputs information indicating that the switching of the driving mode is forbidden to the action plan generator 140. Thus, the action plan generator 140 does not perform the switching. Conversely, when it is determined that the period T6 has passed, the request task determiner 186 outputs information indicating that the switching of the driving mode is permitted to the action plan generator 140 (step S115). Thus, the action plan generator 140 performs the switching.

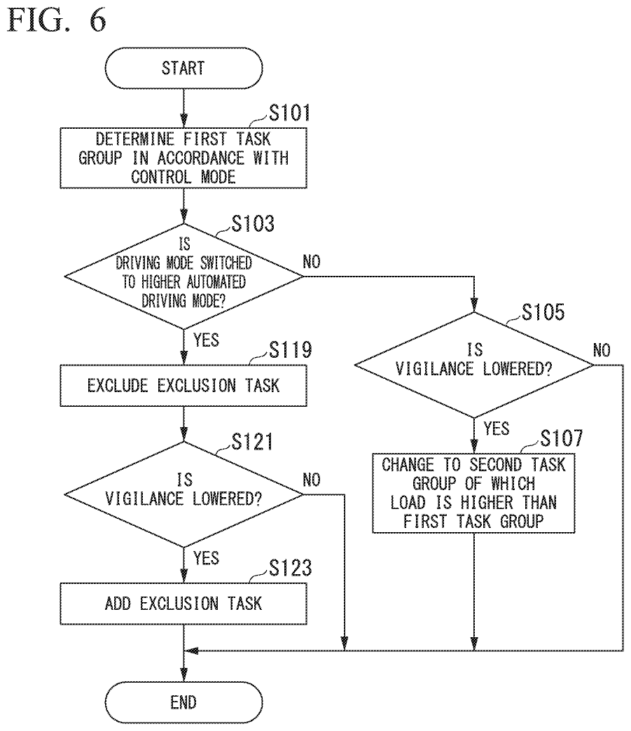

FIG. 6 is a flowchart (part 3) illustrating a flow of processes performed by the request task determiner 186. The same reference numerals are given to the same processes as the processes described in FIG. 4 and detailed description thereof will be omitted. After the first task group is determined in step S101, the request task determiner 186 determines whether the action plan generator 140 switches the driving mode to a higher automated driving mode (step S103). When the driving mode is not switched to the higher automated driving mode, the request task determiner 186 performs steps S105 and S107.

Conversely, when the driving mode is switched to the higher automated driving mode in step S103, the request task determiner 186 determines the first task group in accordance with the switched higher automated driving mode and excludes an exclusion task determined in advance in association with the switched higher automated driving mode from the first task group (step S119). Subsequently, the request task determiner 186 determines whether the vigilance of the driver estimated by the vigilance estimator 184 is lowered (step S121). When it is determined that the vigilance of the driver estimated by the vigilance estimator 184 is not lowered, the request task determiner 186 does not change the request task. Conversely, when it is determined that the vigilance of the driver estimated by the vigilance estimator 184 is lowered, the request task determiner 186 adds the exclusion task to the first task group determined in step S119 (step S123).

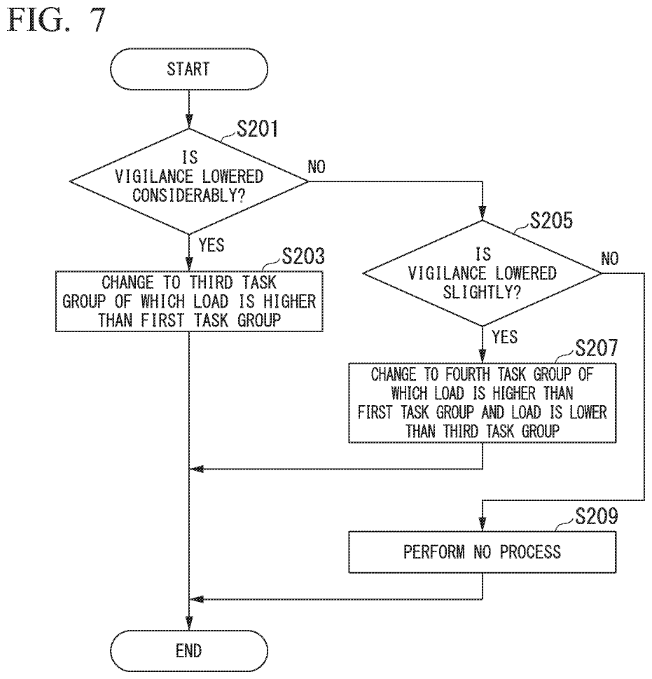

When the vigilance of the driver estimated by the vigilance estimator 184 is lowered, the request task determiner 186 may determine tasks of which loads differ in accordance with the vigilance of the driver. For example, the request task determiner 186 performs processes illustrated in FIG. 7 instead of the processes of steps S105 and S107 described above. FIG. 7 is a flowchart (part 4) illustrating a flow of processes performed by the request task determiner 186.

The request task determiner 186 determines whether the vigilance of the driver estimated by the vigilance estimator 184 is V3 in which the vigilance is considerably lowered (step S201). When the vigilance of the driver is V3 in which the vigilance is considerably lowered, the request task determiner 186 changes the request task to the third task group of which the load is higher than the first task group (step S203). The third task group includes, for example, task 3 in which the driver moves at least a part of his or her body, task 5 in which the driver is caused to perform a motion related to driving, and a task in which the extent of thinking is high in task 4.

Conversely, when the vigilance of the driver is not V3 in which the vigilance is considerably lowered in step S201, the request task determiner 186 determines whether the vigilance of the driver estimated by the vigilance estimator 184 is V2 in which the vigilance is slightly lowered (step S205). When the vigilance of the driver is V2 in which the vigilance is slightly lowered, the request task determiner 186 changes the request task to the fourth task group (step S207). The fourth task group is a task group of which a load is higher than the first task group and a load is lower than the third task group. The fourth task group includes, for example, tasks of which the extent of thinking is low in task 4. The tasks of which the extent of thinking is low in task 4 include supplying information regarding preferences of the driver (merely talking to the driver) and asking a question which is related to a preference of the driver and does not require an answer.

Conversely, when the vigilance of the driver is not V2 in which the vigilance is slightly lowered in step S205 (that is, the vigilance of the driver is the normal state V1), the request task determiner 186 does not perform any process (step S209). That is, the request task is not changed.

According to the above-described first embodiment, the vehicle control system includes the recognizer 130 configured to recognize a surrounding situation of a vehicle; a vehicle controller (the first controller 120 and the second controller 160) configured to perform driving support to control one or both of steering and a deceleration or acceleration of the vehicle based on the surrounding situation recognized by the recognizer 130; the vigilance estimator 184 configured to estimate vigilance of a driver in the vehicle based on a detection result from a detector provided in the vehicle; and the request task determiner 186 configured to determine a task requested of the driver while the driving support is performed by the vehicle controller. The request task determiner 186 raises a load of the task requested of the driver when the vigilance of the driver estimated by the vigilance estimator 184 is lowered. Thus, it is possible to inhibit lowering of the vigilance of the driver.

The content of the task requested of the driver is set as content which can be performed reasonably by the driver during driving, such as a motion of a part of the body, communication, or something associated with the driving. Thus, it is possible to reduce discomfort which the driver may feel even in a situation in which the driver whose vigilance is lowered is requested to perform the request task.

By changing the content of the task requested of the driver in accordance with the vigilance, it is possible to reduce discomfort which the driver may feel.

In a system in which a driving mode of the own vehicle M is switched in accordance with a traveling scenario, such as the vehicle system 1 according to the embodiment, when a change interval of the driving mode is shortened, it is difficult to estimate the vigilance of the driver with high precision in some cases. By requesting the task with the above-described proper content of the driver even in such a situation, it is possible to reduce discomfort which the driver may feel.

### Second Embodiment

Hereinafter, a second embodiment will be described. In the first embodiment, the own vehicle M performs the driving support mainly through the automated driving, as described above. In the second embodiment, driving support of the own vehicle M different from the automated driving of the first embodiment is performed. Hereinafter, differences from the first embodiment will be mainly described.

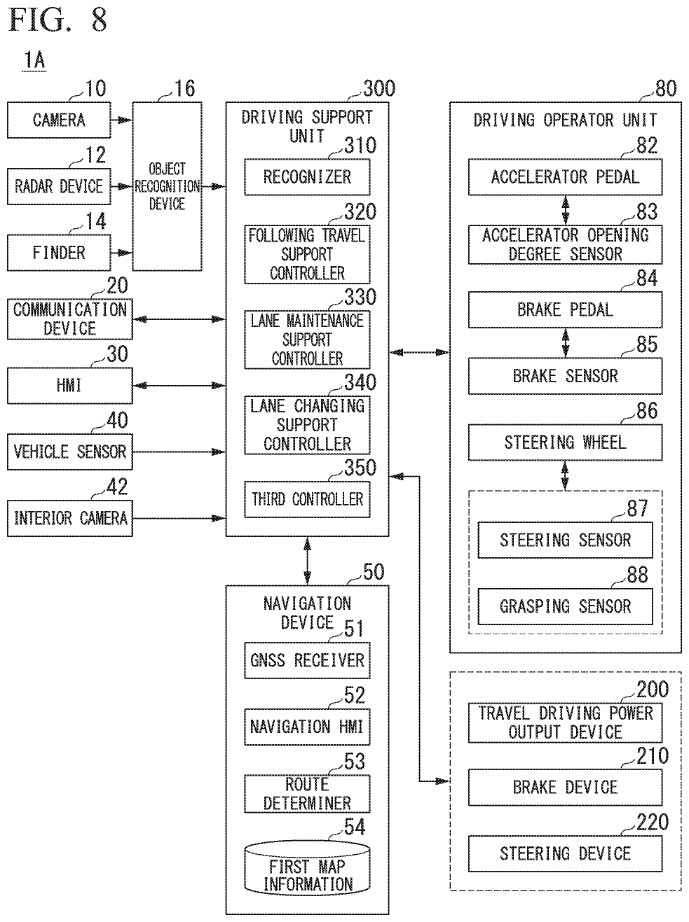

FIG. 8 is a diagram illustrating an example of a functional configuration of a vehicle system 1A according to the second embodiment.

The vehicle system 1A includes, for example, a driving support unit 300 instead of the automated driving control unit 100. In the vehicle system 1A, the MPU 60 is omitted.

The driving support unit 300 includes, for example, a recognizer 310, a following travel support controller 320, a lane maintenance support controller 330, a lane changing support controller 340, and a third controller 350. The recognizer 310 and the third controller 350 have the same functions as the recognizer 130 and the third controller 180, and description thereof will be omitted.

Control of one or more of following travel support control performed by the following travel support controller 320, lane maintenance support control performed by the lane maintenance support controller 330, and lane changing support control performed by the lane changing support controller 340, as will be described below, is an example of “driving support.” The control may be hierarchically sorted in the order in which a load of a task requested of a driver of the own vehicle M in the control of the driving support is higher.

When the vigilance of the driver estimated by the vigilance estimator 184 during execution of the driving support is lowered, the request task determiner 186 instructs the switching controller 188 to switch the driving mode to the manual driving mode, and thus the load of the request task is raised. When the control of the driving support is hierarchically sorted in accordance with the load of the task requested of the driver of the own vehicle M, the request task determiner 186 may change the mode of the driving support to a hierarchically lower mode, and thus the load of the request task may be raised. In this way, since the load on the driver is raised and the driver is caused to perform a motion related to the driving, it is possible to inhibit lowering of the vigilance.

### Following Travel Support Controller 320

For example, the following travel support controller 320 performs control such that the own vehicle M follows a surrounding vehicle traveling to a destination in a traveling direction of the own vehicle M recognized the recognizer 310. The following travel support controller 320 starts the following travel support control using an operation performed on a following travel start switch (not illustrated) by an occupant as a trigger. For example, the following travel support controller 320 controls the travel driving power output device 200 and the brake device 210 and performs speed control of the own vehicle M such that the own vehicle M follows a surrounding vehicle within a predetermined distance (for example, about 50 [m]) in front of the own vehicle M (which is referred to as a front vehicle) among surrounding vehicles recognized by the recognizer 310 and controls a speed of the own vehicle M. The “following” refers to, for example, traveling of the own vehicle M constantly maintaining a relative distance (inter-vehicle distance) between the own vehicle M and the front vehicle. When the recognizer 310 does not recognize the front vehicle, the following travel support controller 320 may cause the own vehicle M to travel at a set vehicle speed simply.

### Lane Maintenance Support Controller 330

The lane maintenance support controller 330 controls the steering device 220 such that the own vehicle M maintains its traveling lane based on a position of the own vehicle M recognized by the recognizer 310. The lane maintenance support controller 330 starts, for example, the lane maintenance support control using an operation performed on a lane maintenance start switch (not illustrated) by an occupant as a trigger. For example, the lane maintenance support controller 330 controls steering of the own vehicle M such that the own vehicle M travels in the middle of its traveling lane. The lane maintenance support controller 330 controls, for example, the steering device 220 such that a larger steering force is output in a direction returning to a position in the middle of the traveling lane as a separation of a standard point of the own vehicle M is larger from the middle of the traveling lane.

Further, when the own vehicle M approaches to a road mark line marking a lane, the lane maintenance support controller 330 may control the steering device 220 to perform a lane deviation inhibition control by controlling steering such that the own vehicle M returns to the middle side of the traveling lane.

### Lane Changing Support Controller 340

The lane changing support controller 340 controls the travel driving power output device 200, the brake device 210, and the steering device 220 such that the own vehicle M is caused to change its lane to an adjacent lane to which the lane is determined to be able to change, irrespective of an operation on the steering wheel by an occupant (steering control). The lane changing support controller 340 starts the lane changing support control, for example, using an operation performed on a lane changing start switch (not illustrated) by an occupant as a trigger. For example, when the operation is performed on the lane changing start switch, control by the lane changing support controller 340 is preferred.

The lane changing support controller 340 derives a distance necessary to change the lane of the own vehicle M based on a speed of the own vehicle M and the number of seconds necessary to change the lane.

When the number of seconds necessary to change the lane is set based on a distance until traveling of a target distance in a lateral direction ends when the distance in the lateral movement at the time of changing of the lane is assumed to be substantially constant and the changing of the lane at an appropriate speed in the lateral direction is assumed to be performed. The lane changing support controller 340 sets an ending spot of the lane changing to the middle of a traveling lane on a lane of a lane changing destination based on the derived distance necessary to change the lane. The lane changing support controller 340 performs the lane changing support control, for example, using the ending spot of the lane changing as a target position.

### Third Embodiment

Hereinafter, a third embodiment will be described. A vehicle system according to the third embodiment has both the function of performing the driving support mainly through the automated driving described in the first embodiment and the function of performing the driving support described in the second embodiment. Hereinafter, differences from the first and second embodiments will be mainly described.

In the embodiment, the driving support mode, the first automated driving mode, the second automated driving mode, and the third automated driving mode are sorted in this order in which the load of the task requested of the driver of the own vehicle M is higher. The driving support mode includes, for example, the following travel support control, the lane maintenance support control, and the lane changing support control described above.

When the vigilance of the driver estimated by the vigilance estimator 184 during execution of the driving support is lowered, the request task determiner 186 raises the load of the request task when the automated driving mode is switched to the driving support mode (or the driving support mode is switched to the manual driving mode). In this way, since the load on the driver is raised and the driver is caused to perform a motion related to the driving, it is possible to inhibit the vigilance from being lowered.

### Hardware Configuration

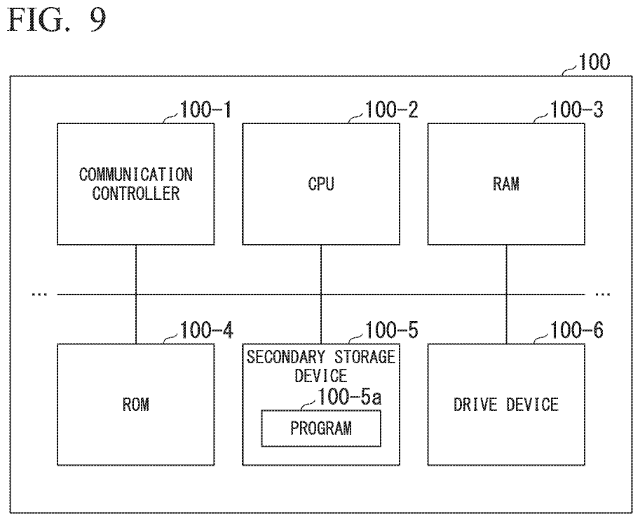

The automated driving control unit 100 of the vehicle system 1 (or the automated support unit 300 of the vehicle system 1A) according to the above-described embodiment is realized by, for example, a hardware configuration illustrated in FIG. 9. FIG. 9 is a diagram illustrating an example of a hardware configuration of the automated driving control unit 100 (the driving support unit 300) according to an embodiment.

A controller is configured such that a communication controller 100-1, a CPU 100-2, a RAM 100-3 a ROM 100-4, a secondary storage device 100-5 such as a flash memory or an HDD, and a drive device 100-6 are configured to be connected to each other via an internal bus or a dedicated communication line. A portable storage medium such as an optical disc is mounted on the drive device 100-6. A program 100-5a stored in the secondary storage device 100-5 is loaded on the RAM 100-3 by a DMA controller (not shown) and is executed by the CPU 100-2 to realize a controller. A program which is referred to by the CPU 100-2 may be stored in a portable storage medium mounted on the drive device 100-6 or may be downloaded from another device via a network NW.

The above-described embodiments can be expressed as follows:

a vehicle control system including a storage device and a hardware processor, the hardware processor executing the program stored in the storage device to perform:

recognizing a surrounding situation of a vehicle;

performing driving support to control one or both of steering and a deceleration or acceleration of the vehicle based on the recognized surrounding situation;

estimating vigilance of a driver in the vehicle based on a detection result from a detector provided in the vehicle;

determining a task requested of the driver while the driving support is performed; and

raising a load of the task requested of the driver when the estimated vigilance of the driver is lowered.

The embodiments for carrying out the present invention have been described above, but the present invention is not limited to the embodiments. Various modifications and substitutions can be made within the scope of the present invention without departing from the gist of the present invention.

For example, the vigilance estimator 184 may change the determination standard of vigilance in accordance with weather, a time zone, or the like in which the own vehicle is traveling. More specifically, since the eyes of the driver are easily tired on a day on which ultraviolet light is strong than on a cloudy day, a threshold (a traveling distance or a traveling time) used to determine that vigilance is low on a day on which ultraviolet light is strong may be less than in a cloudy day. Since driving during the night is drowsier than driving during the day, a threshold (a traveling distance or a traveling time) used to determine that vigilance at night is lowered may be less than during the day.

The “changing to a task with a higher degree of driving association” performed when the request task determiner 186 increases the load of the request task may include, for example, changing of a switching condition that the driving mode is switched from a higher driving mode to the lower driving mode to a switching condition that it is easy to switch the driving mode to the lower driving mode. For example, when the switching from the automated driving mode to the manual driving mode is set in advance as a condition that a state in which the driver grasp the steering wheel 86 continues for a period T7 or more, the length of the period T7 is shortened.

When the request task determiner 186 raises the load of the request task, supplying of a predetermined response to a question to the driver may be included. The predetermined response may include, for example, outputting of music from a speaker mounted in a vehicle in accordance with a response when favorite music is questioned to the driver or supplying of information regarding a restaurant or a store from the HMI 30 in accordance with a response when favorite food is questioned to the driver.

When the request task is not performed under a predetermined condition, the request task determiner 186 may cause predetermined report information to be output from the HMI 30. When a request task set in each automated driving mode is not performed under the predetermined condition, the action plan generator 140 or the switching controller 188 may cause the predetermined report information to be output from the HMI 30. For example, a case in which a situation where the request task is not performed continues for a predetermined time or more or a case in which a situation where the request task related to driving is not performed continues for a predetermined time or more are included under a predetermined condition.

### REFERENCE SIGNS LIST

1, 1A Vehicle system

100 Automated driving control unit

120 First controller

130 Recognizer

140 Action plan generator

160 Second controller

162 Acquirer

164 Speed controller

166 Steering controller

180 Third controller

182 Occupant recognizer

184 Vigilance estimator

186 Request task determiner

188 Switching controller

300 Driving support unit

310 Recognizer

320 Following traveling support controller

330 Lane maintaining support controller

340 Lane changing support controller

350 Third controller

What is claim is:

1. A vehicle control system comprising:
a recognizer configured to recognize a surrounding situation of a vehicle;
a vehicle controller configured to perform driving support to control one or both of steering and a deceleration or acceleration of the vehicle based on the surrounding situation recognized by the recognizer;
a vigilance estimator configured to estimate vigilance of a driver in the vehicle based on a detection result from a detector provided in the vehicle; and
a task determiner configured to determine a task requested of the driver while the driving support is performed by the vehicle controller and configured to raise a load of the task requested of the driver when the vigilance of the driver estimated by the vigilance estimator is lowered.

2. The vehicle control system according to claim 1, wherein, when the task determiner raises the load of the task requested of the driver, the task determiner performs at least one of
increasing the number of tasks requested of the driver,
adding a task of causing the driver to move at least a part of a body of the driver,
raising an extent of thinking of a task of causing the driver to think, and
changing to a task with a higher degree of driving association.

3. The vehicle control system according to claim 1,
wherein the vehicle controller switches between first and second driving modes at a predetermined timing and performs the driving support and switches to the first driving mode when the vigilance of the driver estimated by the vigilance estimator is lowered in the second driving mode, and
wherein the second driving mode is at least one of a driving mode in which a degree of freedom of the driver is higher than that in the first driving mode, a driving mode in which a load of a task request for the driver is less than that in the first driving mode, and a driving mode in which a level of the driving support by the vehicle controller is higher than that in the first driving mode.

4. The vehicle control system according to claim 3, wherein the task determiner
excludes some exclusion tasks among a plurality of tasks requested of the driver in the first driving mode in tasks requested in the second driving mode, and
adds the exclusion tasks to the tasks requested in the second driving mode when the vigilance of the driver estimated by the vigilance estimator is lowered in the second driving mode.

5. The vehicle control system according to claim 4, wherein the exclusion tasks are detected by the detector and include at least one of a task of grasping an operator of the vehicle and a task of causing the driver to monitor a surroundings of the vehicle.

6. The vehicle control system according to claim 3, wherein the vehicle controller
switches between the first and second driving modes at the predetermined timing in accordance with a change in a traveling scenario of the vehicle, and
limits the switching to the second driving mode when a predetermined condition is not satisfied after the switching to the first driving mode due to lowering of the vigilance of the driver estimated by the vigilance estimator in the second driving mode.

7. A vehicle control method causing an in-vehicle computer to perform:
recognizing a surrounding situation of a vehicle;
performing driving support to control one or both of steering and a deceleration or acceleration of the vehicle based on the recognized surrounding situation;
estimating vigilance of a driver in the vehicle based on a detection result from a detector provided in the vehicle;
determining a task requested of the driver while the driving support is performed; and
raising a load of the task requested of the driver when the estimated vigilance of the driver is lowered.

8. A storage medium a computer-readable non-transitory storage medium storing a program, the program causing an in-vehicle computer to perform:
recognizing a surrounding situation of a vehicle;
performing driving support to control one or both of steering and a deceleration or acceleration of the vehicle based on the recognized surrounding situation;
estimating vigilance of a driver in the vehicle based on a detection result from a detector provided in the vehicle;
determining a task requested of the driver while the driving support is performed; and
raising a load of the task requested of the driver when the estimated vigilance of the driver is lowered.
